(19) United States
(12) Patent Application Publication
(10) Pub. No.: US 2010/0276121 A1
(43) Pub. Date: Nov. 4, 2010

(54) Thermal Energy Storage Apparatus

(76) Inventors: Dan Sagie, Beer-sheva (IL); Eli Assis, Beer-sheva (IL)

Correspondence Address: NIXON & VANDERHYE, PC, 901 NORTH GLEBE ROAD, 11TH FLOOR, ARLINGTON, VA, 22203, US

(21) Appl. No.: 12/223,277

(22) PCT Filed: Jan. 25, 2007
(86) PCT No.: PCT/IL2007/000104

§ 371 Date: Jul. 2, 2010

(30) Foreign Application Priority Data
Jan. 26, 2006 (IL) 173373

(51) Int. Cl. F28D 20/02; F28D 15/00; F28F 7/00

(52) U.S. Cl. 165/110; 165/104.28; 165/185

(57) ABSTRACT

The present invention is primarily directed to a thermal energy storage apparatus for delivering thermal energy to or from a PCM, comprising an elongated heat conducting container (10) having an insertable thermal energy transfer element (15) placed therein, wherein said thermal energy transfer element comprises a plurality of heat transfer paths in the form of transversely disposed flexible heat conducting members (16), at least a portion of which are in contact with the inner wall of said container (10). The invention is also directed to a system using the thermal energy storage apparatus of the invention.

### FIELD OF THE INVENTION

The present invention relates to the field of thermal energy storage. More particularly, the invention relates to a phase change materials (PCM) based method and apparatus, with improved thermal conductivity for storing and delivering thermal energy.

### BACKGROUND OF THE INVENTION

Thermal Energy Storage (TES) technologies provide efficient and cost effective solutions in various heat process industries (e.g., solar heat systems). Common TES technologies that are used nowadays might be classified to either sensible heat or fusion heat storage. The present invention aims to provide an efficient fusion heat storage apparatus based on a phase change material.

Phase change thermal energy storage is based on the large heat of fusion of some Phase Change Materials (PCM, e.g., paraffin waxes, inorganic salts). Typically, in this type of energy storage applications the phase of the PCM changes from solid state into liquid state during storage of thermal energy therein, and from liquid state back into solid state while delivering the stored thermal energy therefrom. Liquid to vapor phase change (e.g., steam accumulator), and vice versa, may be similarly used in such applications to store and deliver thermal energy. The addition, or extraction, of thermal energy to/from the PCM results in a change in its phase state with corresponding absorption/rejection of thermal energy.

While the following description mainly relates to PCMs which phase is changed between their solid and liquid phases it should be clear that the present invention pertains also to other types of PCMs, for example, PCMs which phase change between liquid and gaseous states (e.g., water), or between solid and gaseous states.

A preferred approach of PCM based thermal energy storage apparatus designs is to construct the apparatus from a cylindrical container comprising a PCM. The outer surface of the container is being in contact with a circulated heat exchange fluid used for storing or extracting thermal energy to/from the PCM comprised therein. During the process of extracting the thermal energy from the PCM (herein after freezing cycle) the phase of the PCM adjacent to the inner surface of the container is the first to freeze (change from liquid state into solid state), which significantly reduces the heat conductivity of the apparatus, and as a result substantially slows down the heat extraction process. Similarly, storing the thermal energy in the PCM (hereinafter melting cycle) is also substantially slow due to the low heat conductivity of the apparatus while the PCM is in its solid state.

U.S. Pat. No. 6,400,896 describes a heat exchanger comprising heat energy transfer elements extending through the PCM. This heat exchanger is comprised from a container containing the PCM, and the heat energy transfer elements, are located in a lower portion of the container. Heat exchange fluid is circulated in an annular space defined between the outer surface of the container and a tube surrounding the container. The heat energy transfer elements extending through the PCM are electrical resistance heated rods or coils, or tubes through which a high temperature fluid is flowed to initiate melting of the PCM during melt cycles.

U.S. Pat. No. 5,220,954 also describes a heat exchanger comprising a PCM contained in a container surrounded by a tube wherein a heat exchange fluid is circulated in the annular space defined between the outer surface of the container and the surrounding tube. The annular space is divided by at least two divider walls into upper and lower passageways to allow streaming the heat exchange fluid via the lower passageway during the melt cycle, and via the upper passageway during the freeze cycle. One embodiment of the heat exchanger comprises a central tube extending through the central region of the container and connected to the upper flow passageway, wherein heat conducting fins radially extends outwardly from the central tube.

EP 1455155 describes a PCM element comprising a casing including the PCM and an inner tube concentrically disposed in the casing for routing a cooling stream of liquid or gas therethrough. The PCM element further comprises a metal braid or fins attached to the inner tube for rapidly delivering the external heat absorbed via the outer surface of the casing to the interior of the PCM element which may be then discharged via a cooling liquid flowing in the inner tube.

Another proposed solution described in “Thermal energy storage technology industrial process heat applications”, Proceedings of ISEC2005: 2005 international solar energy conference, Aug. 6-12, 2005, Orlando, Fla., by Rainer T. et al, suggests to reduce the heat conduction resistance of PCM storage apparatuses by embedding the PCM in a matrix made of a material with high thermal conductivity.

The methods described above have not yet provided satisfactory solutions for efficiently storing thermal energy in a PCM based thermal energy storage apparatus and rapidly extracting the stored thermal energy therefrom. A cost effective method has not been introduced as well. Therefore there is a need for an improved thermal energy storage apparatus that overcomes the above mentioned problems.

It is therefore an object of the present invention to provide a PCM based method and apparatus which provides improved heat conductivity and thereby enable rapidly, high power storing and extracting of thermal energy.

It is a further object of the present invention to provide a simplified and cost effective method and apparatus for rapidly, high power storing and extracting of thermal energy.

It is another object of the present invention to provide a generic thermal energy storage unit which is suitable for a wide range of applications (e.g. Heat management (regulation) in any Process in the Heat industry).

Other objects and advantages of the invention will become apparent as the description proceeds.

### SUMMARY OF THE INVENTION

It has now been found that it is possible to construct an energy storage apparatus capable of rapidly delivering thermal energy to/from a PCM contained in a heat conducting container comprising a thermal energy transfer element which provides a plurality of heat transfer paths between the central space of the heat conducting container and its inner wall. This new construction allow rapidly delivering thermal energy to/from the apparatus via a heat exchange fluid flowing in contact with the wall of the heat conducting container without requiring that the heat exchange fluid be circulated inside said energy storage apparatus.

The present invention is thus primarily directed to a thermal energy storage apparatus for delivering thermal energy to or from a PCM. The energy storage apparatus preferably comprise an elongated heat conducting container having an insertable thermal energy transfer element placed therein, wherein the thermal energy transfer element comprises a plurality of heat transfer paths in the form of transversely disposed flexible heat conducting members, at least a portion of which are in contact with the inner wall of the heat conducting container, and wherein the plurality of members are arranged along a longitudinal axis of the heat transfer element and occupy cross sectional portions thereof.

The plurality of heat conducting members may be attached to a central supporting member made from a heat conducting rod, tube, conduit, or wires, such that they may be tilted about their lateral axes. The strips or wires are preferably curved in shape of a helical star, the base points of which are attached to the central supporting member and its apex points are in contact with the inner wall of the heat conducting container.

The term helical star generally refers to a helix having a cross-sectional star polygon shape geometry formed by a plurality of base and apex points, such that said base points forms an inner cross-sectional diameter, and said apex points forms an outer cross-sectional diameter, of said helical star.

Advantageously, non overlapping heat conducting paths are obtained in the cross sectional portions of the thermal energy transfer element.

Optionally, the heat conducting members are made from heat conducting wires or strips which may be adhered to, welded to, or threaded through, the central supporting member.

Optionally, the heat conducting members are made from mesh members attached to the central supporting member and in contact with the inner wall of the heat conducting container.

The insertable thermal energy transfer element may be shaped in a form of an elongated star polygon the apex points of which are pressed against the inner wall of said heat conducting container thereby providing a plurality of heat transfer paths between the center of said container and its wall. A central supporting member may be used to support the elongated star element such that its base points are in contact with the outer surface of the supporting member. The elongated star element may comprise transfer apertures provided on its sides for allowing migration of the PCM therethrough. Similarly, transfer apertures may be also provided on the central supporting member for allowing migration of the PCM therethrough.

In another aspect the present invention is directed to a method for manufacturing a thermal energy storage apparatus, comprising providing a heat conducting container, installing a thermal energy transferring element in the heat conducting container, partially or fully filling the interior of said heat conducting container with a PCM via an opening thereof, and sealing the heat conducting container by one or more caps, wherein the thermal energy transfer element is adapted to be flexibly inserted into the heat conducting container such that its heat conducting members are pressed against the inner wall of the heat conducting container.

The heat conducting members of the thermal energy transferring element are preferably attached to a central supporting member.

The thermal energy transferring element and the PCM may be inserted into the heat conducting container via an opening thereof, which is then sealed by a cap such that the internal surface of said cap contacts the tip of the central supporting member, while the other tip of said central supporting member contacts the internal surface of the opposite end of the container. Alternatively, the heat conducting container may comprise two openings, one of which is sealed by a cap before installing the thermal energy transferring element therein and filling its interior by the PCM, and wherein the other opening is sealed by another cap afterwards, such that the internal surface of said caps contacts the tips of the central supporting member.

According to yet a further preferred embodiment the invention is directed to thermal energy storage system comprising a thermally insulated vessel in which thermal energy storage apparatuses are installed, wherein the thermally insulated vessel comprises at least one inlet and at least one outlet for streaming a heat exchange fluid via the interior of the vessel such that the heat exchange fluid streamed therethrough contacts the outer surfaces of the thermal energy storage apparatuses, and wherein some or all of the thermal energy storage comprise a thermal energy transferring element adapted to be flexibly inserted into a heat conducting vessel such that heat conducting members of said thermal energy transferring element are pressed against the inner wall of said heat conducting vessel.

The thermal energy storage apparatuses may comprise central conduits to which the thermal energy transferring elements are attached, the extremities of said central conduits protrudes outwardly from said thermal energy storage apparatuses, wherein the thermally insulated vessel further comprises two auxiliary chambers each of which being in fluid flow communication with said central conduits via their protruding extremities for streaming another heat exchange fluid therethrough.

### BRIEF DESCRIPTION OF THE DRAWINGS

The present invention is illustrated by way of example in the accompanying figures, in which similar references consistently indicate similar elements:

FIGS. 1A to 1C schematically illustrates a thermal energy storage apparatus of the present invention which is implemented utilizing a brush shaped insert;

FIGS. 2A to 2B schematically illustrates a thermal energy storage apparatus of the present invention which is implemented utilizing an elongated star shaped insert;

FIGS. 3A to 3D schematically illustrates a thermal energy storage apparatus of the present invention which is implemented utilizing a helical star shaped insert;

FIGS. 4A to 4B schematically illustrates a thermal energy storage apparatus of the present invention implemented utilizing a mesh insert;

FIG. 5 schematically illustrates a thermal energy storage application comprising a plurality of thermal energy storage tubes;

FIG. 6A schematically illustrates a longitudinal-section view of a thermal energy storage apparatus of the present invention having a central conduit;

FIG. 6B schematically illustrates a thermal energy storage application having two different flow paths for heat exchange fluids; and

FIG. 7 graphically illustrates the results of the computerized simulation described in Example 3.

### DETAILED DESCRIPTION OF PREFERRED EMBODIMENTS

The present invention provides a PCM based thermal energy storage apparatus (also referred to as energy storage tube) in which the thermal energy transfer is substantially improved by increasing the apparatus heat conductivity, thereby providing relatively fast and efficient thermal energy storage and release times. As will be described in details hereinbelow the thermal energy storage apparatus of the present invention is relatively simple and easy to construct and its manufacture costs are relatively low.

In general, the thermal energy storage apparatus of the present invention is comprised of a heat conducting container (e.g., tube) comprising a PCM and a heat conducting insert comprising a plurality of heat conducting members, wherein said heat conducting members pass in the inner space of the heat conducting container and in thermal contact with its inner wall. In this way a plurality of heat conducting paths are obtained between the central space of the container and its inner wall, which substantially improve the heat conductivity of the apparatus. The central member is preferably manufactured from heat conducting material(s) in form of a rod, hollow tube, conduit, or braid of wires. The PCM is preferably a type of inorganic salt such as NaNO₃.

Due to this unique structure of the thermal energy storage apparatus of the invention the thermal energy stored in the PCM in a central space thereof can be efficiently delivered to a heat exchange fluid via the insert provided therein and via its walls. More particularly, the plurality of heat conducting paths, obtained by the heat conducting members of the insert between the central space of the heat conducting container and its wall, maintain good heat conductivity despite the rapid solidification of the PCM at the periphery near the walls of the container. Consequently, the stored thermal energy is rapidly delivered and thereby the freezing cycles are substantially shortened and the melting cycles are accelerated.

The heat conducting insert can be implemented in various ways, for example the insert can be manufactured in a shape of a brush with a plurality of heat conducting bristles, in a shape of a helical star with multiple star polygon shaped members, or a combination thereof. Other types of inserts, such as having a mesh members or elongated star shapes, will be also exemplified hereinbelow.

The structure of the thermal energy storage apparatus of the present invention is simple and therefore its construction is relatively easy as well. An elongated tube, having at least one opening, is preferably used as a heat conducting container in which the heat conducting insert of the invention is installed such that its heat conducting elements are pressed against its inner wall. The heat conducting insert of the invention is preferably pushed into the tube via an opening thereof, after which the tube is filled with the PCM and its openings) are sealed.

The thermal energy storage apparatus of the invention may be used in the typical tubes and shell concept of structure, wherein a plurality of thermal energy storage tubes are arranged in parallel in a shell through which a heat exchange fluid is routed in contact with the outer surface of the storage apparatuses.

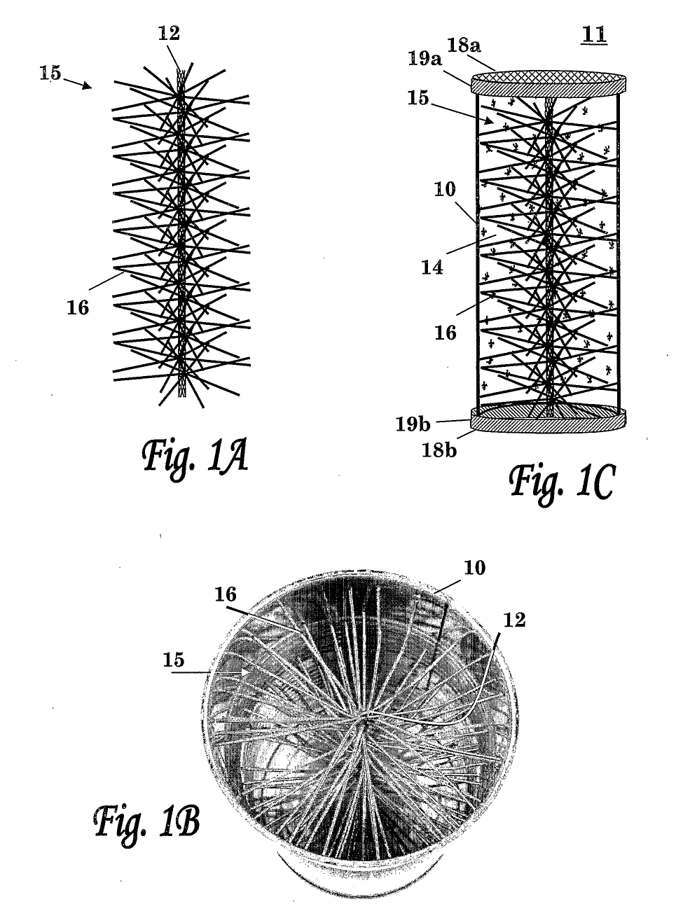

FIGS. 1A to 1C schematically illustrates one preferred embodiment of the invention wherein the heat conducting insert 15 is implemented in a shape of a brush (hereinafter referred to as brush insert) comprising a plurality of heat conducting bristles made from metal wires (or ribbons) 16. The thermal energy storage apparatus 11 is preferably made from a heat conducting tube 10 comprising one or more opening(s) through which its inner space may be accessed. Tube 10 may be structured from a metallic material, such as Aluminum or copper, preferably from carbon steal, which is favorable for operating temperatures in the range of 300 to 600° C. However, other materials may be found suitable for constructing thermal energy storage apparatus 11 in configurations that are designed to operate in different temperatures. Tube 10 may be formed in different geometrical shapes such as circular, elliptic, polygonal or star polygon shapes. According to a preferred embodiment of the invention tube 10 is made in a cylindrical shape having a diameter generally in the range of 20 to 200 mm, and thickness generally in the range of 1 to 5 mm.

Brush insert 15 is inserted into tube 10 preferably by pushing it into the tube 10 via an opening thereof. Heat conducting wires (or ribbons) 16 of brush insert 15 are preferably made from a heat conducting metal such as Aluminum, Copper, etc., preferably from Aluminum. The diameter of heat conducting wires 16 is generally in the range of 0.5 to 2 mm, and their length is generally in the range of 10 to 100 mm (about half of tube diameter).

Heat conducting wires 16 are attached to central member 12 at various points along its longitudinal length and extend outwardly therefrom, preferably radially, in a bristle like fashion. Central member 12 is preferably made from a heat conducting metal, such as aluminum or steel, preferably from copper. The diameter of brush insert 15 is generally in the range of 20 to 200 mm, preferably about 100 mm, and its length is about the same length as of tube 10. In this way, after insertion of insert 15 into tube 10 and sealing the same by the top and bottom covers, 18a and 18b, heat conducting wires 16 are pressed against the inner wall of tube 10 and the top and bottom tips of central member 12 are pressed against the inner sides of top and bottom covers, 18a and 18b, respectively.

Central member 12 may be implemented by a rod and heat conducting wires may be welded or adhered thereto, or winded thereon. According to one preferred embodiment of the invention central member 12 is made from a braid of metal wires and heat conducting wires are threaded therethrough, such that two portions of each threaded wire extends outwardly therefrom, preferably radially, in more or less opposite directions.

Top and bottom covers 18a and 18b are preferably made from a heat conducting material, preferably from the same material tube 10 is made of. The diameter of covers 18 is adjusted to provide effective sealing of tube 10. Covers 18 preferably comprise annular protrusions 19a and 19b vertically protruding from the plane of covers 18 at their edges, where said annular protrusions are adjusted to fit over the circumferential outer surface of the end portions of tube 10 and thereby tightly seal its openings.

After insertion of insert 15 into tube 10 and sealing at least one opening thereof by a cover 18 the PCM 14 may be introduced into tube 10, followed by sealing the other opening(s) of tube 10 by suitable covers 18. The inner space of tube 10 is preferably entirely filled by a PCM 14. PCM 14 may comprise one or more types of PCM materials which are well known in the art. For example, for temperature of about 300° C. the PCM is preferably comprised of NaNO₃.

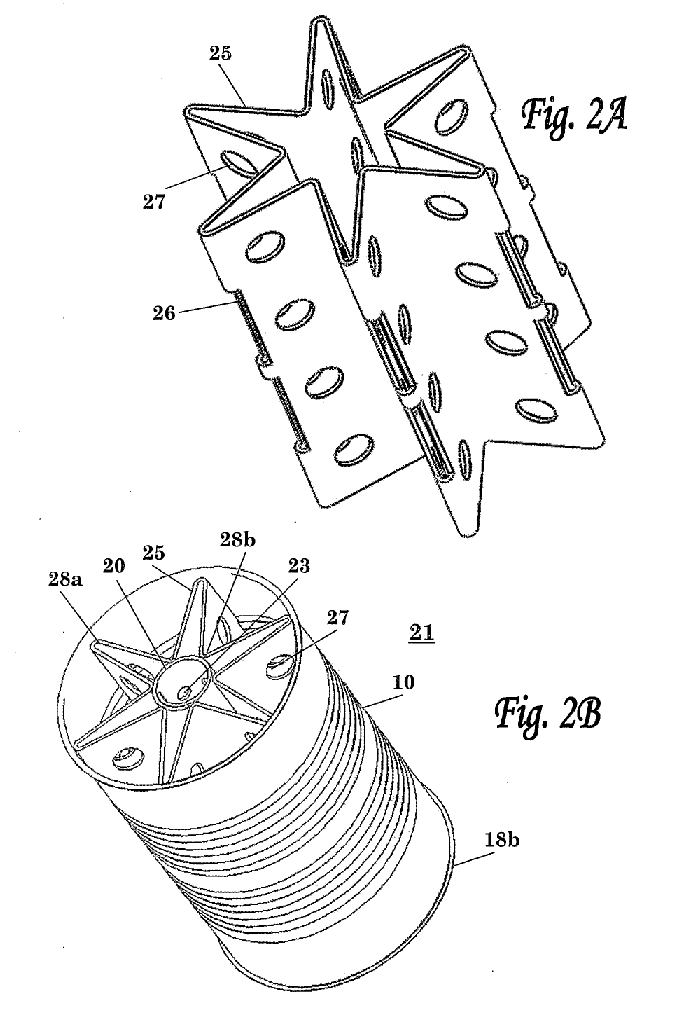

FIGS. 2A to 2B illustrate another possible heat conducting insert that may be used in a thermal energy storage apparatus 21 of the present invention. The heat conducting insert 25 in this preferred embodiment is formed in a shape of an elongated star polygon (hereinafter referred to as star insert) having a cross-sectional star polygon shape and a hollow interior which may be accessed via its end openings. Star insert 25 further comprise transfer apertures 27 communicating between its inner and external surrounding space. Transfer apertures 27 provided on the sides of star insert 25 allow PCM 14 (not shown in FIGS. 2A and 2B) to migrate in the inner space of thermal energy storage apparatus 21.

Star insert 25 is preferably made from a heat conducting material, such as Copper, preferably from Aluminum. The number of points (apexes) in the star polygon shape of star insert 25 may be selected according to the specific implementation. In a preferred embodiment of the invention star shape insert 25 is formed as a six point star (having hexagram cross-sectional geometry) from a flat metal sheet comprising transfer apertures 27, and which may further comprise bending slits 26 for facilitating the bending of the metal sheet into the requisite elongated star polygon shape. The thickness of the metal sheet is generally in the range of 0.5 to 4 mm, preferably about 1 mm.

After inserting star insert 25 into tube 10 its apex points 28a may be firmly pressed against the inner wall of tube 10 by inserting an elongated forcing element 20 into its center. In this way portions of the outer surface of forcing element are pressed against base points 28b of star insert 25 thereby applying a radial force thereon and radially pressing apex points 28a. Forcing element 20 may be constructed from any suitable material (e.g., heat conducting and/or resilient), as known in the art. It is preferably made from a heat conducting sheet, such as copper, preferably from aluminum, rolled into a form of an elongated tube having radial resiliency about its longitudinal axis for applying radial forces on points 28a and 28b, thereby pressing apex points 28a against the inner wall of tube 10. Transfer apertures 23 may be provided at different locations along the forcing element 20 to allow migration of PCM therethrough.

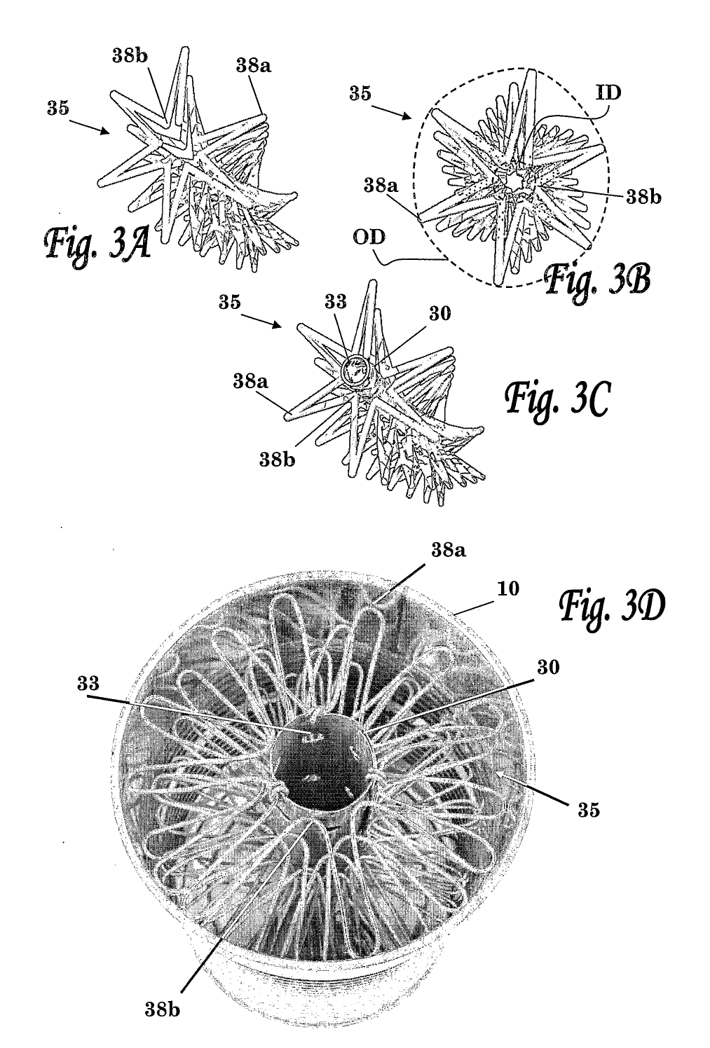

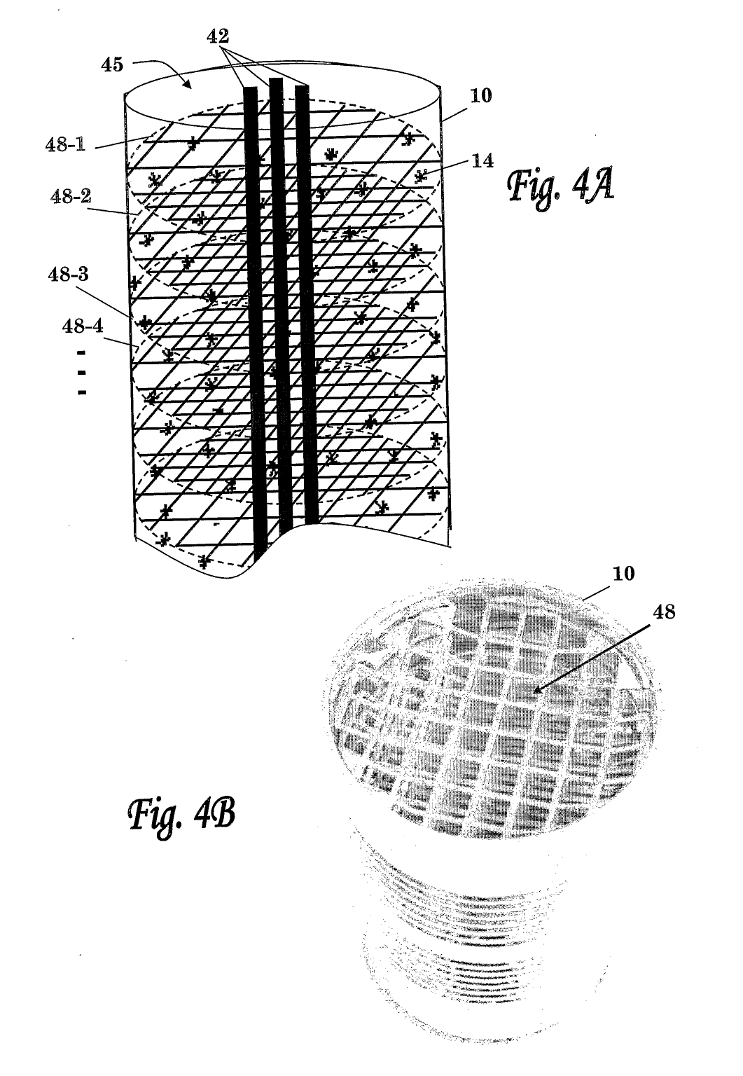

FIGS. 3A to 3D demonstrate a further insert embodiment 35 constructed in form of a helical star (hereinafter referred to as helical star insert). Helical star insert 35 is preferably made from a heat conducting wire (or ribbon) curved in a form which includes a plurality of apex points 38a, placed on the cross-sectional outer diameter OD, and base points 38b, placed on the cross-sectional inner diameter ID, and which are attached at circumferential points to a central support 30. The attachment points of base points 38b along the outer surface of central support 30 are preferably distributed annularly about the central axis of central support in form of a helix such that the distance of successive base points 38b from one of the central support's ends gradually increase. Apex points 38a form a similar helix shape, such that when helical star 35 is inserted into tube 10, apex points 38a are pressed against its inner wall annularly about the central axis of tube 10 at circumferential points which their distance from one of the tube's ends gradually increase.

As shown in FIGS. 3A and 3B helical star insert 35 may be also implemented without central support 30. FIGS. 3C and 3D demonstrates the helical star insert 35 of the invention when implemented with central support 30, wherein FIG. 3D shows such an implementation when inserted into a tube 10.

Central support 30 may be constructed from any type of suitable material (e.g., heat conducting and/or resilient), as known in the art. It is preferably made from a heat conducting sheet, such as copper, preferably from aluminum, rolled into a form of an elongated tube having radial resiliency about its longitudinal axis for applying radial forces on points 38a and 38b, thereby pressing apex points 38a against the inner wall of tube 10. Transfer apertures 33 may be provided at different locations along central support 30 to allow migration of PCM therethrough.

Some, or all, of base points 38b may be welded, adhered, or attached by wire windings to central support 30. Central support 30 is preferably made from a heat conducting sheet, such as copper, preferably from aluminum, rolled into an elongated tube form, and in such implementation it preferably further comprise transfer apertures 33 at different locations thereon to enable migration of PCM therethrough.

FIGS. 4A to 4B demonstrate an insert embodiment 45 wherein the insert is constructed from a plurality of circular heat conducting mesh members, 48-1, 48-2, 48-3, . . . ,. As shown in FIG. 4A, mesh members 48-1, 48-2, 48-3, . . . , may be attached to central rod(s) 42. Mesh members 48 may be welded, adhered, or attached by wire windings to central rod(s) 42. The diameter of mesh members 48 is adjusted according to the diameter of tube 10 to allow fitting them tightly thereinto such that their circumferences are pressed against its inner wall. Mesh members may be fabricated from a heat conducting mesh made from a type of steel or copper, preferably from aluminum, and their thickness is generally in the range of 0.5 to 4 mm, preferably about 1 mm. Rod(s) 42 is preferably made from a heat conducting material, such as copper or aluminum, preferably from steel, and its diameter is generally in the range of 1 to 6 mm, preferably about 2 mm.

FIG. 5 illustrates a preferred tubes and shell implementation utilizing thermal heat storage apparatuses, 10-1, 10-2, 10-3, . . . , of the present invention. In this implementation a plurality of thermal heat storage apparatuses (e.g., tubes), 10-1, 10-2, 10-3, . . . , are placed in parallel inside thermally insulated vessel 500, along its length. Vessel 500 may be constructed from a cylindrical hollow medium sealed by end caps 501 and 502 attached to end openings. While in this example vessel 500 is horizontally positioned such that its longitudinal axis is parallel to the ground surface, it should be noted that it may be similarly positioned vertically, namely—such that its longitudinal axis is perpendicular to the ground surface.

Heat exchange fluid inlet 504 is preferably provided at the lower lateral side of vessel 500, near one end thereof (e.g., 501), and a heat exchange fluid outlet 503 is preferably provided at the upper lateral side of vessel 500, near its other end (e.g., 502). Of course, the heat exchange fluid may flow in the other direction. Thermal heat storage apparatuses 10-1, 10-2, . . . , are fastened inside vessel 500 via a set of tube supporting partitions 50 and 51.

The upper tube supporting partitions 50-1, 50-2, . . . , extends downwardly from the inner top sections of vessel 500, and lower tube supporting partitions 51-1, 52-2, . . . , extends upwardly from the inner bottom sections of vessel 500. Upper and lower tubes supporting partitions 50 and 51 are placed in intertwining form, thereby forcing a flow path (indicated by arrow 505) of heat exchange fluid 509 the direction of which alternates inside vessel 500, namely—the flow direction is zigzagged between up and down flow directions. In this way the heat exchange between thermal storage apparatuses 10-1, 10-2, . . . , and the heat transfer fluid is maximized.

Vessel 500 may be fabricated from a ferrous material, such as steel, preferably from carbon steel. As will be understood by those skilled in the art the range of the geometrical dimensions of vessel 500 should be adjusted according to the requirements of each specific application. Accordingly, the design of vessel 500 should consider the number of thermal storage apparatuses that vessel 500 should comprise and the desirable length of said apparatuses. In this way thermal storage apparatuses may be horizontally installed therein via upper and lower tubes supporting partitions 50 and 51 such that a minimal gap is obtained between their ends and the inner surface of end caps 501 and 502.

End caps 501 and 502 may be fabricated from any suitable material. For example, caps 501 and 502 may be fabricated from the same material from which vessel 500 is made. Caps 501 and 502 are adjusted to fit over the outer surfaces of end section of vessel 500 and seal its end openings. Upper and lower tubes supporting partitions 50 and 51 may be fabricated from a type of steel, preferably from carbon steel, and they are designed to block about 90% of the cross section area of vessel 500. Heat exchange fluid 506 may comprise thermal oil, in a preferred embodiment of the invention it comprises Therminol VP1 of Solutia (St. Louis, USA) or Syltherm 800 of Dow Chemicals, and its flow rate inside vessel 500 is selected to maintain optimal heat transfer.

The flow rate of heat transfer fluid 509 during the melting cycle may generally be in the range of 20 to 100 m³/Hr for a 1 MWₜₕh storage unit (thermal megawatt-hour), and during the freezing cycle in the range of 40 to 200 m³/Hr for said unit.

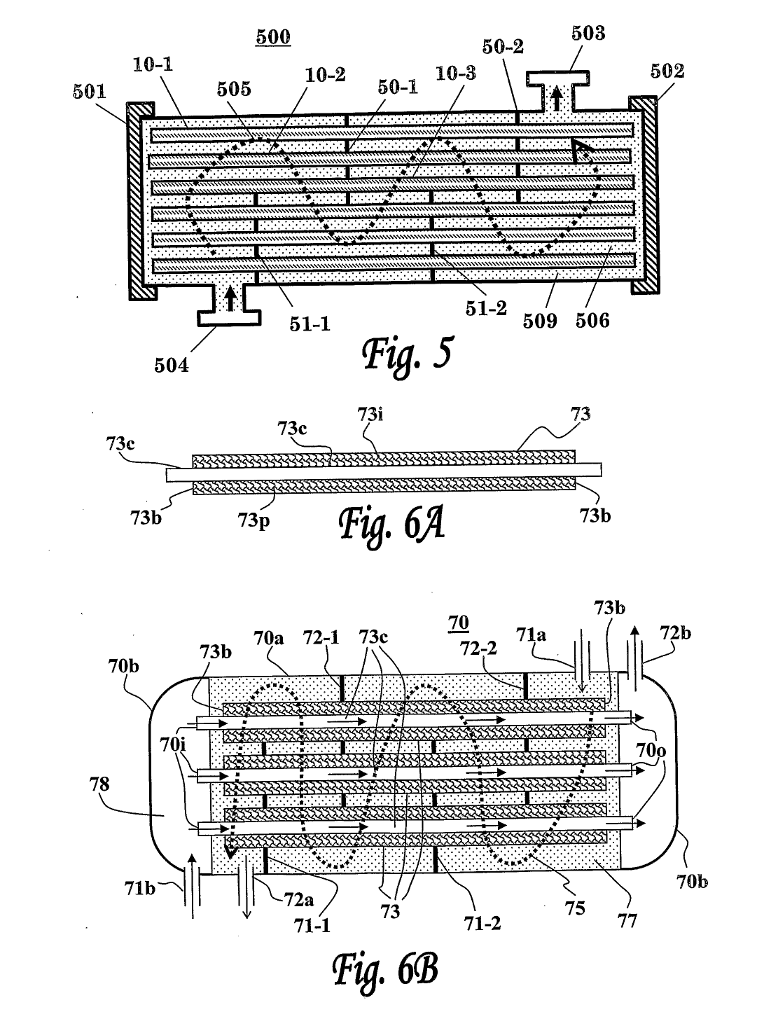

FIG. 6A schematically illustrates a longitudinal-section view of a thermal energy storage apparatus 73 of the present invention having a central conduit 73c passing longitudinally along its length in thermal contact with the heat conducting insert 73i contained therein. As shown in FIG. 6A, the interior of thermal energy storage apparatus 73 is filled with a PCM 73p, and the ends of central conduit 73c protrudes outwardly from the bases 73b of thermal energy storage apparatus 73.

Most preferably, internal conduit 73c is used as a central support element of the heat conducting insert such that it passes coaxially along the length of the thermal energy storage apparatuses 73c having the heat conducting elements of said heat conducting insert attached to its external surface. Internal conduit 73c is preferably used as a central member of heat conducting insert 73i, for example, internal conduit 73c may be used as forcing element 20 of star insert 25 (shown in FIG. 2B), as central support 30 of helical star insert 35 (shown in FIGS. 3C-3D), and/or as central rod 42 of heat conducting insert 45 (shown in FIG. 4A).

FIG. 6B schematically illustrates a thermal energy storage implementation comprising a vessel 70 and thermal energy storage apparatuses 73, said vessel 70 and thermal energy storage apparatuses 73 are configured such that two different flow paths for heat exchange fluids are formed. In this embodiment of the invention the thermal energy storage apparatuses 73 comprise an internal conduit 73c, as described hereinabove with reference to FIG. 6A. As shown in FIG. 6B, the extremities of internal conduits 73c protrudes outwardly from the bases 73b of thermal energy storage apparatuses 73 such that their interiors are accessible via opening 70i and 70o thereof.

Vessel 70 comprises a main chamber 70a in which thermal energy storage apparatuses 73 are installed, and two auxiliary chambers 70b. Energy storage apparatuses 73 are installed in the main chamber 70a such that portions of the extremities of internal conduits 73c are introduced into auxiliary chambers 70b thereby providing fluid flow communication between the interiors of said auxiliary chambers 70b and of said internal conduits 73c.

Main chamber 70a comprises a fluid inlet 71a and a fluid outlet 72a through which a first heat transfer fluid 77 may be streamed. Fluid inlet 71a and fluid outlet 72a are preferably provided on opposing lateral sides of main chamber 70a at longitudinally distant locations. For example, as exemplified in FIG. 6, fluid inlet 71a is provided near one end of main chamber 70a while fluid outlet 72a is provided at the opposing lateral side near the other end of main chamber 70a.

Each of the auxiliary chambers 70b comprises at least one fluid port for streaming a second heat transfer fluid 78 therebetween via internal conduits 73c of energy storage apparatuses 73. As shown in FIG. 6, a first fluid port 71b provided in one auxiliary chamber 70b may be used as inlet, while another fluid port 72b, which may be located on an opposing lateral side of vessel 70, in the other auxiliary chamber 70b, may used as an outlet of said second heat exchange fluid.

Vessel 70 preferably comprises upper partitions 72-1, 72-2, . . . , extending downwardly from the inner top sections of main chamber 70a, and lower partitions 71-1, 71-2, . . . , extending upwardly from the inner bottom sections of main chamber 70a. Upper and lower partitions 71 and 72 are placed in intertwining form, thereby forcing a flow path (designated by arrow 75) of a first heat transfer fluid 77 the direction of which alternates inside main chamber 70a, namely—the flow direction is zigzagged between up and down flow directions.

Vessel 70 may be made from a ferrous material, such as steel, preferably from carbon steel. The volume of main chamber 70a may generally be of about 13,000 liters for a 1 MWₜₕh unit, and the volume of each of the auxiliary chambers 70b may generally be in the range of 800 to 2000 liters.

Internal conduits 73c may be made from a metallic material, such as Aluminum or copper, preferably from carbon steal. The inner diameter of internal conduits 73c may generally be of about 30 mm for a 1 MWₜₕh unit, and their lengths may generally be in the range of 3 to 6 meters for that unit.

The first heat exchange fluid passed via main chamber 70a is preferably used for transferring thermal energy to the energy storage apparatuses 73 contained therein, and it may be implemented by water (or steams) or by type of oil, preferably by a heat transfer oil, such as, but not limited to, Therminol VP1 of Solutia.

The second heat exchange fluid passed via auxiliary chambers 70b is preferably used for removing thermal energy from the energy storage apparatuses 73 contained therein, and it may be implemented by water (or steams) or by type of oil, preferably by water steams.

It should be noted that the thermal energy storage of the apparatus of the present invention is suitable for a wide range of thermal energy storage applications. The same energy storage tubes may be used in various ranges of powers/energies, and they may be adjusted to operate in different temperatures simply by choosing a suitable PCM. The present invention therefore provides a generic solution for thermal heat storage applications, which may be easily adjusted to suit the specific requirements.

All of the abovementioned parameters are given by way of example only, and may be changed in accordance with the differing requirements of the various embodiments of the present invention. Thus, the abovementioned parameters should not be construed as limiting the scope of the present invention in any way. In addition, it is to be appreciated that the different tubes, containers, and other members, described hereinabove may be constructed in different shapes (e.g. having oval, square etc. form in plain view) and sizes from those exemplified in the preceding description.

### Example 1

Table 1 lists the results obtained in a set of simulating experiments which were performed using a small test model. These experiments were carried out using a thermal energy storage apparatus constructed from a cylindrical tube having a diameter of 100 mm, made from steel in a thickness of 1 mm. The cylindrical tube was filled with a NaNO₃/KNO₃ mixture having 250° C. fusion temperature, and it was tested without thermal energy transferring insert and with the various insert types demonstrated hereinabove. The thermal energy storage apparatus was installed in a container through which PazTherm22 heat transfer fluid was circulated. During the melting cycle the temperature of the heat transfer fluid was 260° C. which heated the PCM to about 250° C., and it was cooled to 240° C. for releasing the stored thermal energy in the freezing cycle.

TABLE 1

| | Duration of stored energy |
|---|---|
| Insert type | extraction[min] |
| No insert | 128 |
| Brush insert | 32 |
| Elongated star insert | 40 |
| Spiral star insert | 40 |
| Mesh insert | 34 |

The time required for complete extraction of the stored energy is presented in table 1 for the same tube without inserts, and with inserts of several designs. As shown in table 1 there were significant improvements in the performance of the energy storage apparatus when tested with a thermal energy transferring insert. These experimental results show that the time duration required for the storage tube to deliver its energy is substantially shortened (to about ⅓ tripling the power) when the thermal energy transferring insert was used.

### Example 2

The following demonstration is a specific example for a thermal energy storage system of the invention that is designed to operate in 307° C. using NaNO₃ as a PCM and VP1 as heat transfer fluid. This system is designed for storing about 1 MWₜₕh within 4 hours (i.e., power of 250 kWₜₕ) and for delivering the same in about 2 hours (i.e., power of 500 kWₜₕ).

In this example the thermal energy storage apparatus is implemented utilizing an elongated heat conducting tube containing the PCM and an elongated aluminum star insert. The elongated star insert consists of six apex points and it is of the same length as the heat conducting tube.

Table 2 provides geometric parameters of the exemplified thermal energy storage apparatus:

TABLE 2

| Parameter | Size/Quantity | Notes |
|---|---|---|
| Tube inner diameter | 10 cm | |
| Tube length | 400 cm | made of Carbide Steel |
| Tube volume | 31.416 liter | |
| Number of tubes | 310 | |
| Total volume | 9739 liter | |
| Latent heat per | 0.116 kWₜₕh/ | |
| liter | liter | |
| Fill coefficient - | 0.9 | |
| PCM filling factor | | |
| Total energy storage | 1016.7 kWₜₕh | for 100% efficiency |
| Tubes fill | 0.79 | |
| coefficient - Volume | | |
| of tubes to vessel | | |
| volume ratio | | |
| Thickness of tube | 0.15 cm | |
| wall | | |
| Vessel's inner | 204 cm | |
| diameter | | |
| Vessel's volume | 13074 liter | |
| Volume of energy | 10332.1 liter | |
| storage tubes | | |
| Volume of heat | 2742 liter | |
| transfer fluid | | |
| Heat transfer fluid | 28.2% | |
| to PCM volume ratio | | |
| PCM weight | 22010 Kg | density of about 2.6 |
| | | at fusion temperature |
| Sensible heat in | 14.38 kWₜₕh/10° C. | THERMINOL VP-1 |
| heat transfer fluid | | |
| Heat transfer fluid | 26.93 liter/sec | |
| flow rate required | | |
| for transferring the | | |
| heat in 2 Hours | | |

(kWₜₕh—thermal kilowatt-hour)

### Example 3

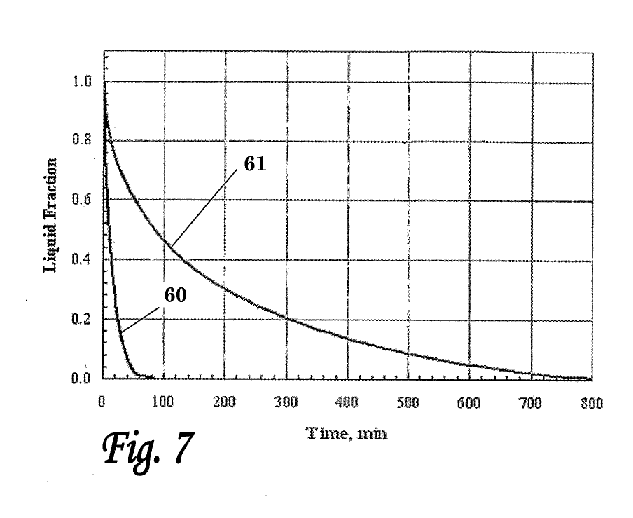

FIG. 7 graphically illustrates the results obtained in a computerized simulation in which the heat transfer of the thermal energy storage apparatus of the invention was tested, and wherein the configuration of the simulated heat transfer apparatus was as follows: the heat conducting tube of the apparatus is a steel tube having a 100 mm inner diameter and comprising an elongated star insert made of pure Aluminum (e.g., Aluminum 1100) having 6 apex points and 1 mm thickness. In the simulation SylTherm800 oil was used as a heat transfer fluid and the temperature difference between the heat transfer fluid and the melted PCM salt (NaNO₃) was 10° C.

FIG. 7 shows the results of the computerized simulation, wherein the curves shown illustrates the rate of solidification over time which represents the power extracted from the tube assembly. Curve 60 illustrates the results obtained in a simulation of the heat transfer apparatus containing the elongated star insert, and curve 61 illustrates the results obtained in a simulation in which the heat transfer apparatus of the invention contained only the PCM salt (without heat transfer insert). The vertical axis of the graph in FIG. 7 relates to the changes of the PCM state between its liquid (1.0) and solid (0.0) states.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1-32. (canceled)

33. A thermal energy storage apparatus for delivering thermal energy to or from a PCM, comprising an elongated heat conducting container having an insertable thermal energy transfer element placed therein, wherein said thermal energy transfer element comprises a plurality of heat transfer paths in the form of transversely disposed flexible heat conducting members, at least a portion of which are in contact with the inner wall of said container, and wherein said plurality of members are arranged along a longitudinal axis of said element and occupy cross sectional portions thereof.

34. The thermal energy storage apparatus of claim 33, wherein the plurality of heat conducting members are attached to a central supporting member thereof such that they may be tilted about their lateral axes.

35. The thermal energy storage apparatus of claim 33, wherein non overlapping heat conducting paths are obtained in the cross sectional portions of the thermal energy transfer element.

36. The thermal energy storage apparatus of claim 33, wherein the heat conducting members are made from heat conducting wires or strips.

37. The thermal energy storage apparatus of claims 36, wherein the wires or strips are adhered to, welded to, or threaded through, the central supporting member.

38. The thermal energy storage apparatus of claim 34, wherein the central supporting member is made from a heat conducting rod, tube, conduit, or wires.

39. The thermal energy storage apparatus according to claim 34, wherein the central supporting member is made from a conduit suitable for streaming a heat exchange fluid therethrough.

40. The thermal energy storage apparatus of claim 33 wherein the heat conducting members are curved in a shape of a helical star, the apex points of which are in contact with the inner wall of the heat conducting container.

41. The thermal energy storage apparatus of claim 40, wherein the base points of the helical star are attached to the central supporting member.

42. The thermal energy storage apparatus of claim 33, wherein the heat conducting members are made from mesh members attached to the central supporting member and in contact with the inner wall of the heat conducting container.

43. A thermal energy storage apparatus for delivering thermal energy to or from a PCM, comprising an elongated heat conducting container having an insertable thermal energy transfer element placed therein, wherein said thermal energy transfer element is shaped in a form of an elongated star the apex points of which are pressed against the inner wall of said heat conducting container thereby providing a plurality of heat transfer paths between the center of said container and its wall.

44. The thermal energy storage apparatus of claim 43, further comprising a central supporting member, wherein the base points of the elongated star are in contact therewith.

45. The thermal energy storage apparatus according to claim 44, wherein the central supporting member is made from a conduit suitable for streaming a heat exchange fluid therethrough.

46. The thermal energy storage apparatus of claim 43, further comprising transfer apertures provided on the sides of the elongated star insert for allowing migration of the PCM therethrough.

47. The thermal energy storage apparatus of claim 44, comprising transfer apertures provided on the central supporting member for allowing migration of the PCM therethrough.

48. An elongated thermal energy transfer element suitable to be placed in a longitudinal heat conducting container for delivering thermal energy to or from a PCM, said thermal energy transfer element comprising a plurality of heat transfer paths in the form of transversely disposed flexible heat conducting members, wherein said thermal energy transferring element is adapted to be flexibly inserted into said heat conducting container such that at least a portion of said heat conducting members are in contact with the inner wall of said container when placed therein, and wherein said plurality of members are arranged along a longitudinal axis of said element and occupy cross sectional portions thereof.

49. The thermal energy transfer element of claim 48, wherein the plurality of heat conducting members are attached to a central supporting member thereof such that they may be tilted about their lateral axes.

50. The thermal energy transfer element according to claim 49, wherein the central supporting member is made from a heat conducting conduit suitable for streaming a heat exchange fluid therethrough.

51. The thermal energy transfer element of claim 48 wherein non overlapping heat conducting paths are obtained in cross sectional portions thereof.

52. The thermal energy transfer element of claim 51, wherein the heat conducting members are made from heat conducting wires or strips.

53. The thermal energy transfer element of claim 52, wherein the wires or strips are adhered to, welded to, or threaded through, the central supporting member.

54. The thermal energy transfer element of claim 50, wherein the central supporting member is made from a heat conducting rod, tube, conduit, or wires.

55. The thermal energy transfer element of claim 48, wherein the heat conducting members are curved in a shape of a helical star, the apex points of which are adapted to be in contact with the inner wall of the heat conducting container when said thermal energy transfer element is inserted therein.

56. The thermal energy transfer element of claim 55, wherein the base points of the helical star are attached to the central supporting member.

57. The thermal energy transfer element of claim 49, wherein the heat conducting members are made from mesh members attached to the central supporting member and adapted to be in contact with the inner wall of the heat conducting container when said thermal energy transfer element is inserted therein.

58. An elongated thermal energy transfer element suitable to be placed in a longitudinal heat conducting container for delivering thermal energy to or from a PCM, said thermal energy transfer element is shaped in a form of an elongated star the apex points of which are adapted to be pressed against the inner wall of said heat conducting container thereby providing a plurality of heat transfer paths between the center of said container and its wall when said thermal energy transfer element is placed therein.

59. The thermal energy transfer element of claim 58, further comprising a central supporting member, wherein the base points of the elongated star are in contact therewith.

60. The thermal energy transfer element according to claim 59, wherein the central supporting member is made from a heat conducting conduit suitable for streaming a heat exchange fluid therethrough.

61. The thermal energy transfer element of claim 59, wherein the central supporting member is made from a heat conducting rod, tube, or conduit.

62. The thermal energy transfer element of claim 58, further comprising transfer apertures provided on the sides of said element for allowing migration of PCM therethrough.

63. The thermal energy transfer element of claim 59, further comprising transfer apertures provided on the central supporting member for allowing migration of PCM therethrough.

64. A thermal energy storage system for delivering thermal energy to or from a PCM comprising a thermally insulated vessel in which thermal energy storage apparatuses are installed, wherein said thermally insulated vessel comprise at least one inlet and at least one outlet for streaming a heat exchange fluid via the interior of said vessel such that the heat exchange fluid streamed therethrough contacts the outer surfaces of said thermal energy storage apparatuses, and wherein some or all of said thermal energy storage apparatuses comprise a thermal energy transferring element adapted to be flexibly inserted therein such that heat conducting members thereof are pressed against the inner wall of said heat conducting vessel, and wherein: said thermal energy transferring element is shaped in a form of an elongated star the apex points of which are pressed against the inner wall of said thermal energy storage apparatuses; or, said thermal energy transferring comprises a plurality of heat transfer paths in the form of transversely disposed flexible heat conducting members, at least a portion of which are in contact with the inner wall of said thermal energy storage apparatuses, and wherein said plurality of members are arranged along a longitudinal axis of said element and occupy cross sectional portions thereof.

65. A thermal energy storage system according to claim 64, wherein the thermal energy storage apparatuses comprise central conduits to which the thermal energy transferring elements are attached, the extremities of said central conduits protrudes outwardly from said thermal energy storage apparatuses, and wherein the thermally insulated vessel further comprises two auxiliary chambers each of which being in fluid flow communication with said central conduits via their protruding extremities for streaming another heat exchange fluid therethrough.
